(19) United States
(12) Patent Application Publication
(10) Pub. No.: US 2023/0038454 A1
(43) Pub. Date: Feb. 9, 2023

(54) VIDEO SEARCH SYSTEM, VIDEO SEARCH METHOD, AND COMPUTER PROGRAM

(71) Applicant: NEC Corporation, Minato-ku, Tokyo (JP)

(72) Inventors: Yousuke MOTOHASHI, Tokyo (JP); Mayo TAKETA, Tokyo (JP)

(73) Assignee: NEC Corporation, Minato-ku, Tokyo (JP)

(21) Appl. No.: 17/791,376

(22) PCT Filed: Sep. 30, 2020
(86) PCT No.: PCT/JP2020/037243

§ 371 Date: Jul. 7, 2022

Related U.S. Application Data
(60) Provisional application No. 62/960,334, filed on Jan. 13, 2020.

(51) Int. Cl. G06F 16/78; G06F 16/73; G06F 16/75; G06F 16/783

(52) U.S. Cl. CPC G06F 16/7867; G06F 16/73; G06F 16/75; G06F 16/7837

(57) ABSTRACT

A video search system includes: an object tag acquisition unit that obtains an object tag associated with an object that appears in a video; a search query acquisition unit that obtains a search query; a similarity calculation unit that calculates a similarity degree between the object tag and the search query; and a video search unit that searches for a video corresponding to the search query on the basis of the similarity degree. According to such a video search system, it is possible to properly recognize the video, for example, by using the search query using a natural language.

### TECHNICAL FIELD

The present invention relates to a video search system, a video search method, and a computer program that search for a video or picture.

### BACKGROUND ART

A known system of this type searches for a desired video from a large amount of video data. For example, Patent Literature 1 discloses a technique/technology of searching for a video by extracting image feature quantity for each frame from videos. Patent Literature 2 discloses a technique/technology of searching for a video by using a still image for search query.

### CITATION LIST

### Patent Literature

Patent Literature 1: JP2015-114685A
Patent Literature 2: JP2013-92941A

### SUMMARY

### Technical Problem

As an example of a search method, a method that uses a natural language is considered. In the techniques/technologies described in Patent Literatures 1 and 2 described above, however, only a search that uses an image is assumed, and it is hard to search for a video or picture by using the natural language.

The present invention has been made in view of the above problems, and it is an example object of the present invention to provide a video search system, a video search method, and a computer program that are configured to appropriately search for a desired video or picture.

### Solution to Problem

A video search system according to an example aspect of the present invention includes: an object tag acquisition unit that obtains an object tag associated with an object that appears in a video; a search query acquisition unit that obtains a search query; a similarity calculation unit that calculates a similarity degree between the object tag and the search query; and a video search unit that searches for a video corresponding to the search query on the basis of the similarity degree.

A video search method according to an example aspect of the present invention includes: obtaining an object tag associated with an object that appears in a video; obtaining a search query; calculating a similarity degree between the object tag and the search query; and searching for a video corresponding to the search query on the basis of the similarity degree.

A computer program according to an example aspect of the present invention operates a computer: to obtain an object tag associated with an object that appears in a video; to obtain a search query; to calculate a similarity degree between the object tag and the search query; and to search for a video corresponding to the search query on the basis of the similarity degree.

### Effect of the Invention

According to the video search system, the video search method, and the computer program in the respective aspects described above, it is possible to appropriately search for a desired video, and in particular, it is possible to appropriately perform video search that uses a natural language.

### BRIEF DESCRIPTION OF DRAWINGS

FIG. 1 is a block diagram illustrating a hardware configuration of a video search system according to a first example embodiment.

FIG. 2 is a block diagram illustrating a functional block provided by the video search system according to the first example embodiment.

FIG. 3 is a table illustrating an example of an object tag.

FIG. 4 is a block diagram illustrating a configuration of a video search system according to a modified example of the first example embodiment.

FIG. 5 is a flowchart illustrating a flow of operation of the video search system according to the first example embodiment.

FIG. 6 is a block diagram illustrating a functional block provided by a video search system according to a second example embodiment.

FIG. 7 is a table illustrating an example of words corresponding to a cluster.

FIG. 8 is a flowchart illustrating a flow of operation of the video search system according to the second example embodiment.

FIG. 9 is a block diagram illustrating a functional block provided by a video search system according to a third example embodiment.

FIG. 10 is a block diagram illustrating a configuration of a video search system according to a modified example of the third example embodiment.

FIG. 11 is a flowchart illustrating a flow of operation of the video search system according to the third example embodiment.

FIG. 12 is a block diagram illustrating a functional block provided by a video search system according to a fourth example embodiment.

FIG. 13 is a flowchart illustrating a flow of operation of the video search system according to the fourth example embodiment.

### DESCRIPTION OF EXAMPLE EMBODIMENTS

Hereinafter, a video search system, a video search method, and a computer program according to example embodiments will be described with reference to the drawings.

### First Example Embodiment

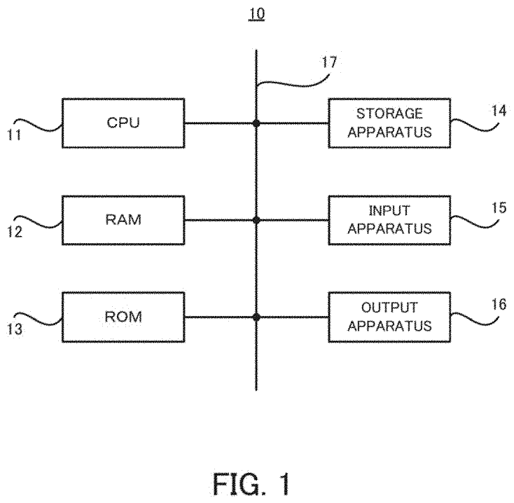

First, a video search system according to a first example embodiment will be described with reference to FIG. 1 to FIG. 5.

### (Hardware Configuration)

With reference to FIG. 1, a hardware configuration of a video search system according to a first example embodiment will be described. FIG. 1 is a block diagram illustrating the hardware configuration of the video search system according to the first example embodiment.

As illustrated in FIG. 1, a video search system 10 according to the first example embodiment includes a CPU (Central Processing Unit) 11, a RAM (Random Access Memory) 12, a ROM (Read Only Memory) 13, and a storage apparatus 14. The video search system 10 may also include an input apparatus 15 and an output apparatus 16. The CPU 11, the RAM 12, the ROM 13, the storage apparatus 14, the input apparatus 15, and the output apparatus 16 are connected through a data bus 17.

The CPU 11 reads a computer program. For example, the CPU 11 is configured to read a computer program stored by at least one of the RAM 12, the ROM 13 and the storage apparatus 14. Alternatively, the CPU 11 may read a computer program stored by a computer readable recording medium by using a not-illustrated recording medium reading apparatus. The CPU 11 may obtain (i.e., read) a computer program from a not-illustrated apparatus that is located outside the video search system 10 through a network interface. The CPU 11 controls the RAM 12, the storage apparatus 14, the input apparatus 15, and the output apparatus 16 by executing the read computer program. Especially in the example embodiment, when the CPU 11 executes the read computer program, a functional block for searching for a video or picture is implemented in the CPU 11.

The RAM 12 temporarily stores the computer program to be executed by the CPU 11. The RAM 12 temporarily stores the data that is temporarily used by the CPU 11 when the CPU 11 executes the computer program. The RAM 12 may be, for example, a D-RAM (Dynamic RAM).

The ROM 13 stores the computer program to be executed by the CPU 11. The ROM 13 may otherwise store fixed data. The ROM 13 may be, for example, a P-ROM (Programmable ROM).

The storage apparatus 14 stores the data that is stored for a long term by the video search system 10. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the video search system 10. The input apparatus 15 may include, for example, at least one of a keyboard, a mouse, and a touch panel.

The output apparatus 16 is an apparatus that outputs information about the video search system 10 to the outside. For example, the output apparatus 16 may be a display apparatus (e.g., a display) that is configured to display the information about the video search system 10.

### (Functional Configuration)

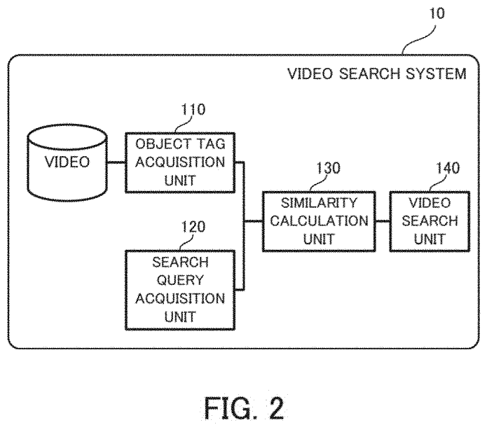

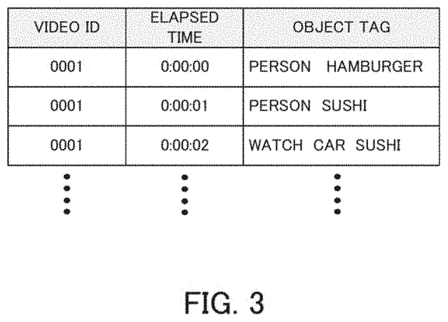

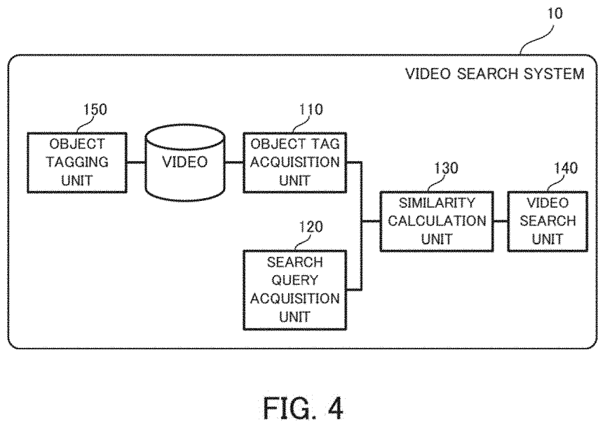

Next, a functional configuration of the video search system 10 according to the first example embodiment will be described with reference to FIG. 2 to FIG. 4. FIG. 2 is a block diagram illustrating the functional block provided by the video search system according to the first example embodiment. FIG. 3 is a table illustrating an example of an object tag. FIG. 4 is a block diagram illustrating a configuration of a video search system according to a modified example of the first example embodiment.

As illustrated in FIG. 2, the video search system 10 according to the first example embodiment is configured to search for a desired video or picture (specifically, a video corresponding to a search query inputted by a user) from accumulated videos or pictures. The video that is a search target includes, but is not particularly limited to, for example, a video lifelog. The video may be accumulated, for example, in the storage apparatus 14 (see FIG. 1) or the like, or may be accumulated in a storage unit external to the system (e.g., a server, etc.). The video search system 10 includes, as functional blocks for realizing its function, an object tag acquisition unit 110, a search query acquisition unit 120, a similarity calculation unit 130, and a video search unit 140. These functional blocks are implemented, for example, in the CPU 11 (see FIG. 1).

The object tag acquisition unit 110 is configured to obtain an object tag from the accumulated videos. The object tag is information about an object that appears in a video, and is associated with each object in the video. However, a plurality of object tags may be associated with one object. The object tag is typically a common noun, but may be associated as a proper noun, for example, by performing an identity test or the like (i.e., it may be a unique identification information that individually identifies an object). The object tag may also indicate information other than the name of an object (e.g., shape, property, etc.). The object tag acquisition unit 110 may obtain the object tag, for example, in frame units of a video. The object tag acquisition unit 110 may include a storage unit that stores the obtained object tag. The object tag may be stored in the storage unit in each frame unit of each video, for example, as illustrated in FIG. 3. The object tag obtained by the object tag acquisition unit 110 is configured to be outputted to the similarity calculation unit 130.

The search query acquisition unit 120 is configured to obtain a search query inputted by the user. The search query includes information about a video desired by the user (i.e., a video to be searched for). The search query is inputted, for example, as a natural language. The search query in this case may include, for example, multiple words or phrases. An example of the search query that is a natural language includes “a sandwich that I ate while using a computer,” “a distillation still that I visited,” and “lunch that I had in Hokkaido,” or the like. The user may input the search query, for example, by using the input apparatus 15 (see FIG. 1, etc.). The search query obtained by the search query acquisition unit 120 is configured to be outputted to the similarity calculation unit 130.

The similarity calculation unit 130 is configured to compare the object tag obtained by the object tag acquisition unit 110 with the search query obtained by the search query 120 and to calculate a similarity degree between the two. The “similarity degree” is calculated as a quantitative parameter indicating a degree to which the object tag is similar to the search query. The similarity degree may be calculated for each of a plurality of videos, or may be calculated for each predetermined period of the video. The predetermined period in this case may be appropriately determined in accordance with the video, and may be variable. The similarity calculation unit 130 may have a function of dividing the search query into a plurality of words (search terms), for example, by using a dictionary or a morphological analysis. In this case, the similarity calculation unit 130 may calculate the number of coincidences between the object tag and the search term as the similarity degree. The number of coincidences between the object tag and the search term may be calculated, for example, in units of preset sum-up times (e.g., 1 minute, 1 hour, or the like). The similarity degree calculated by the similarity calculation unit 130 is configured to be outputted to the video search unit 140.

The similarity calculation unit 130 may calculate the similarity degree in accordance with an aspect when an object appears in the video. For example, the similarity calculation unit 130 may calculate the similarity degree on the basis of a length of a period in which an object appears in the video, a ratio in size of the object to the video, or the like. More specifically, for an object that appears in the video for a long period of time, an object that appears to be large, or an object that appears close to a camera that captures the video, the similarity calculation unit 130 may calculate the similarity degree of the object tag to be high. On the other hand, for an object that appears in the video only for an extremely short amount of time, or an object that appears to be small, or an object that appears far from the camera that captures the video, the similarity calculation unit 130 may calculate the similarity degree of the object tag to be low. In this way, it is possible to increase the accuracy of the video search based on the similarity degree described later.

The video search unit 140 searches for a video corresponding to the search query, on the basis of the similarity degree calculated by the similarity calculation unit 130. The video search unit 140 outputs, for example, a video in which the similarity degree satisfies a predetermined condition, as a search result. In this case, there may be a plurality of videos to be outputted. Alternatively, the video search unit 140 may output a video with the highest similarity degree, or may output a plurality of videos with high similarity degrees, as the search result. Furthermore, the video search unit 140 may have a function of reproducing the video outputted as the search result. In addition, the video search unit 140 may have a function of displaying an image indicating the video outputted as the search result, like a thumbnail.

As illustrated in FIG. 4, the video search system 10 may include an object tagging unit 150. The object tagging unit 150 associates an object that appears in the video with the object tag, for example, by using an object recognition model that is machine-learned in advance. A specific method of recognizing an object and adding the object tag can use the existing techniques/technologies, as appropriate. When the video search system 10 includes the object tagging unit 150, it is possible to perform the video search even when the object tag is not added to the video. That is, the video search system 10 is configured to perform video search after the object tagging unit 150 adds the object tag to the video. On the other hand, when the video search system 10 does not include the object tagging unit 150, a video to which the object tag is added may be prepared in advance. In this case, the object tag may be automatically added by video analysis, or may be manually added.

### (Description of Operation)

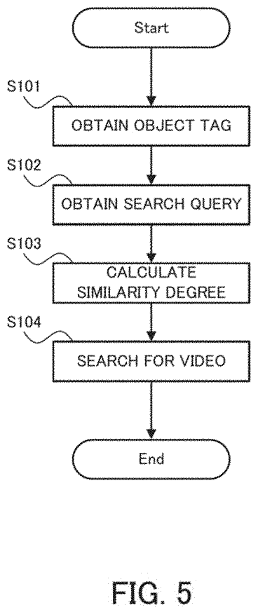

Next, a flow of operation of the video search system 10 according to the first example embodiment will be described with reference to FIG. 5. FIG. 5 is a flowchart illustrating the flow of the operation of the video search system according to the first example embodiment.

As illustrated in FIG. 4, in operation of the video search system 10 according to the first example embodiment, first, the object tag acquisition unit 110 obtains the object tag from the accumulated videos (step S101). In the configuration in which the object tagging unit 150 is provided, the object tag may be added by the object tagging unit 150 before the step S101.

The search query acquisition unit 120 then obtains the search query inputted by the user (step S102). Then, the similarity calculation unit 130 calculates the similarity degree between the object tag obtained by the object tag acquisition unit 110 and the search query obtained by the search query acquisition unit 120 (step S103).

Finally, the video search unit 140 searches for the video corresponding to the search query on the basis of the similarity degree (step S104). The video search system 10 may be configured to narrow down the search result. In this case, after a new search query is obtained by the search query acquisition unit 120, the step S103 (i.e., the calculation of the similarity degree) and the step S104 (i.e., the video search based on the similarity degree) may be performed again.

### (Technical Effect)

Next, a technical effect obtained by the video search system 10 according to the first example embodiment will be described.

As described in FIG. 1 to FIG. 4, in the video search system 10 according to the first example embodiment, the video search is performed on the basis of the similarity degree between the object tag and the search query. Therefore, it is possible to appropriately search for the video corresponding to search query. Especially in the video search system 10 according to the first example embodiment, even when the search query is inputted as the natural language, the user can appropriately search for a desired video.

Incidentally, such a technical effect may be remarkably exhibited in the video search, for example, of a lifelog or the like. People hardly remember all behaviors and situations clearly, and often remember them, fragmentarily and vaguely. According to the video search system 10 in the first example embodiment, however, since the video search using the search query in the natural language can be performed, even if some information is lacking in the search query, it is possible to search for a desired video from a large number of videos. In other words, it is possible to realize a highly accurate video search while allowing some ambiguity.

### Second Example Embodiment

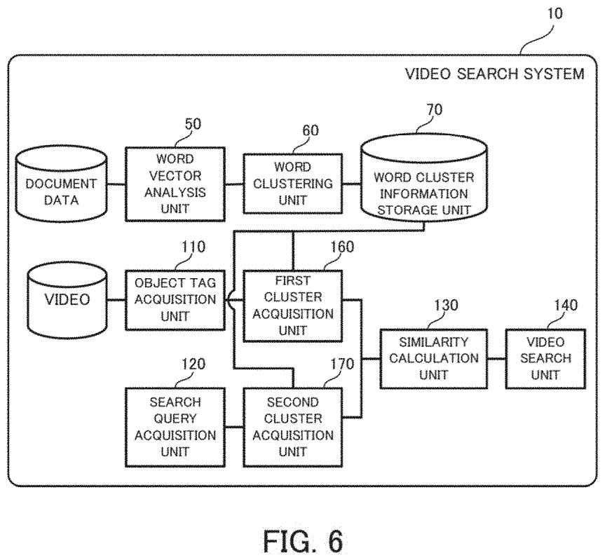

Next, the video search system 10 according to a second example embodiment will be described with reference to FIG. 6 to FIG. 8. The second example embodiment is partially different from the first example embodiment described above only in the configuration and operation (specifically, in that a cluster is used to calculate the similarity degree), and is substantially the same in the other parts. Therefore, the parts that differ from those of the first example embodiment will be described in detail below, and the other overlapping parts will not be described.

### (Functional Configuration)

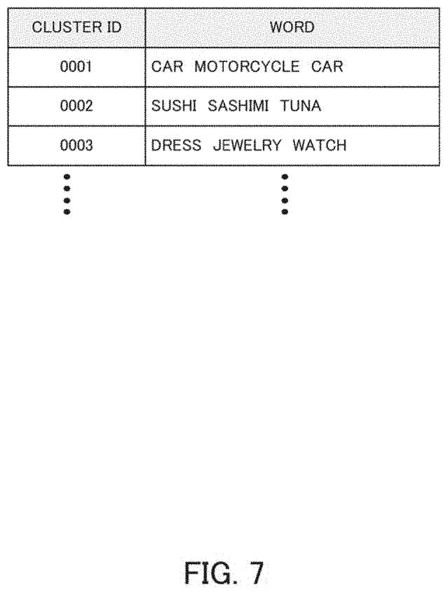

First, a functional configuration of the video search system 10 according to the second example embodiment will be described with reference to FIG. 6 and FIG. 7. FIG. 6 is a block diagram illustrating the functional block provided by the video search system according to the second example embodiment. FIG. 7 is a table illustrating an example of words corresponding to a cluster. Incidentally, in FIG. 6, the same components as those illustrated in FIG. 2 carry the same reference numerals.

As illustrated in FIG. 6, the video search system 10 according to the second example embodiment includes a word vector analysis unit 50, a word clustering unit 60, a word cluster information storage unit 70, the object tag acquisition unit 110, the search query acquisition unit 120, the similarity calculation unit 130, the video search unit 140, a first cluster acquisition unit 160, and a second cluster acquisition unit 170. That is, the video search system 10 according to the second example embodiment further includes a word vector analysis unit 50, a word clustering unit 60, a word cluster information storage unit 70, a first cluster acquisition unit 160, and a second cluster 170 in addition to the configuration in the first example embodiment (see FIG. 2).

The word vector analysis unit 50 is configured to analyze document data and to convert words included in a document into vector data (hereinafter referred to as a “word vector” as occasion demands). The document data may be a general document such as, for example, a web site or a dictionary, or may be a document related to a video (e.g., a document related to business and services of a photographer of the image) or the like. When the document related to a video is used, it is possible to analyze similarity based on technical terms related to the video rather than similarity of general words. The word vector analysis unit 50 makes conversion to the word vector, for example, by using a wordEmbedding method such as a word2vec, or a docEmbedding method such as a doc2vec. The word vector generated by the word vector analysis unit 50 is configured to be outputted to the word clustering unit 60.

The word clustering unit 60 is configured to cluster words on the basis of the word vector generated by the word vector analysis unit 50. The word clustering unit 60 may perform clustering on the basis of the similarity in vector of words. The word clustering unit 60 performs clustering by k-means, for example, on the basis of a cos similarity degree and a Euclidean distance between the word vectors. A clustering method, however, is not particularly limited. A clustering result of the word clustering unit 60 is configured to be outputted to the word cluster information storage unit 70.

The word cluster information storage unit 70 is configured to store the result of clustering by the word clustering unit 60. For example, as illustrated in FIG. 7, the word cluster information storage unit 70 stores an ID of each cluster and the words that belong to each cluster. The word cluster information storage unit 70 stores the information in a state in which the information is appropriately available by the first cluster acquisition unit 160 and the second cluster acquisition unit 170.

The first cluster acquisition unit 160 is configured to obtain a cluster (hereinafter referred to as a “first cluster” as appropriate) to which the information included in the object tag obtained by the object tag acquisition unit 110 belongs, by using the information stored in the word cluster information storage unit 70 (i.e., the clustering result). The information included in the object tag includes, but is not limited to, words included in the object tag. The first cluster may be a cluster based on a vector that represents the object tag. The information about the first cluster obtained by the first cluster acquisition unit 160 is configured to be outputted to the similarity calculation unit 130.

The second cluster acquisition unit 170 is configured to obtain a cluster (hereinafter referred to as a “second cluster” as appropriate) to which the information included in the search query obtained by the search query acquisition unit 120 (typically, the words included in the search query) belongs, by using the information stored in the word cluster information storage unit 70 (i.e., the clustering result). The second cluster may be a cluster based on a vector that represents the search query. The information about the second cluster obtained by the second cluster acquisition unit 170 is configured to be outputted to the similarity calculation unit 130.

### (Description of Operation)

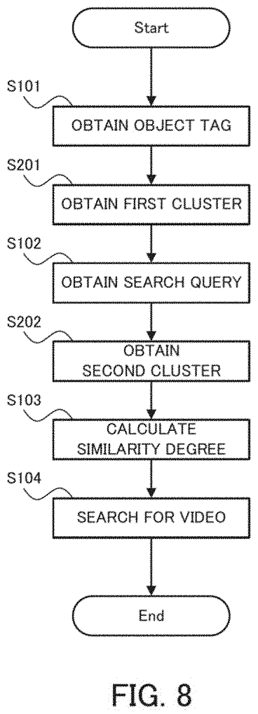

Next, a flow of operation of the video search system 10 according to the second example embodiment will be described with reference to FIG. 8. FIG. 8 is a flowchart illustrating the flow of the operation of the video search system according to the second example embodiment. Incidentally, in FIG. 8, the same steps as those illustrated in FIG. 5 carry the same reference numerals. In the following, the description will be made on the assumption that the word clustering using the document data (i.e., a process by the word vector analysis unit 50 and the word clustering unit 60) is performed and that the result is already stored in the word cluster information storage unit 70.

As illustrated in FIG. 8, in operation of the video search system 10 according to the second example embodiment, first, the object tag acquisition unit 110 obtains the object tag from the accumulated videos (the step S101). Then, the first cluster acquisition unit 160 obtains the first cluster to which the information included in the object tag belongs, by using the clustering result stored in the word cluster information storage unit 70 (step S201). For example, the first cluster acquisition unit 160 queries the word cluster information storage unit 70 about each of the words included in the object tag obtained from the video, and obtains the cluster ID corresponding to each word.

The search query acquisition unit 120 then obtains the search query inputted by the user (the step S102). Then, the second cluster acquisition unit 170 obtains the second cluster to which the information included in the search query belongs, by using the clustering result stored in the word cluster information storage unit 70 (step S202). For example, the second cluster acquisition unit 170 queries the word cluster information storage unit 70 about each of the search terms included in the search query, and obtains the cluster ID corresponding to each search term.

Subsequently, the similarity calculation unit 130 calculates the similarity degree between the object tag and the search query, by comparing the first cluster and the second cluster (the step S103). In other words, the similarity degree in the second example embodiment is calculated as a similarity degree between the first cluster (i.e., the cluster to which the object tag belongs) and the second cluster (i.e., the cluster to which the search query belongs). When the similarity degree is calculated, the video search unit 140 searches for and outputs the video corresponding to the search query on the basis of the similarity degree (the step S104).

The similarity degree between the first cluster and the second cluster can be calculated as the cos similarity degree when a cluster information on the first cluster and a cluster information on the second cluster are regarded as vectors. For example, when the cluster information on the first cluster is Va and the cluster information on the second cluster is Vb, the similarity degree between the first cluster and the second cluster can be calculated by using the following equation (1).

(Va∥Va∥)·(Vb/∥Vb∥) (1)

wherein ∥Va∥ and ∥Vb∥ is the norm of Va and Vb, respectively.

### (Technical Effect)

Next, a technical effect obtained by the video search system 10 according to the second example embodiment will be described.

As described in FIG. 6 to FIG. 8, in the video search system 10 according to the second example embodiment, the similarity is calculated by using the cluster to which the words included in the object tag belongs and the cluster to which the words included in the search query belongs. In this way, the similarity between the object tag and the search query can be calculated as a more appropriate value. Therefore, it is possible to search for the video corresponding to the search query more appropriately.

### Third Example Embodiment

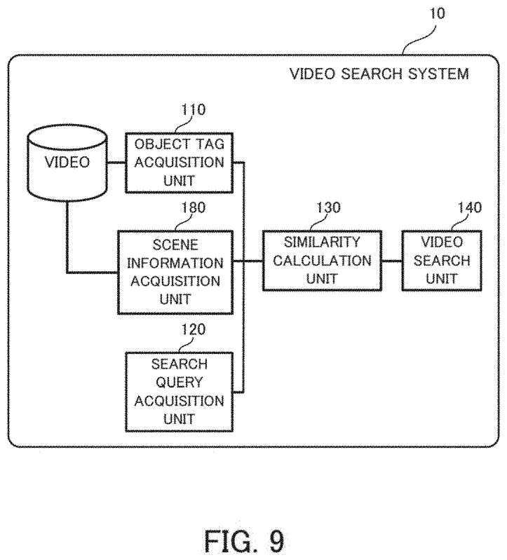

Next, the video search system 10 according to a third example embodiment will be described with reference to FIG. 9 to FIG. 11. The third example embodiment is partially different from the first and second example embodiments described above only in the configuration and operation (specifically, in that a scene information is used), and is substantially the same in the other parts. Therefore, the parts that differ from those of the first and second example embodiments will be described in detail below, and the other overlapping parts will not be described.

### (Functional Configuration)

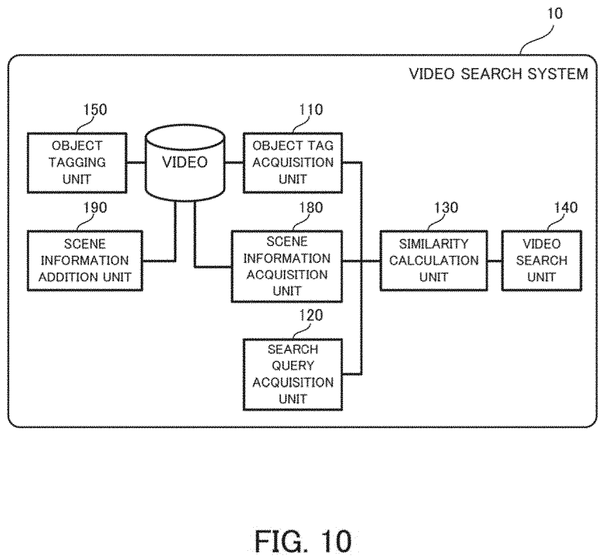

First, a functional configuration of the video search system 10 according to the third example embodiment will be described with reference to FIG. 9 and FIG. 10. FIG. 9 is a block diagram illustrating the functional block provided by the video search system according to the third example embodiment. FIG. 10 is a block diagram illustrating a configuration of a video search system according to a modified example of the third example embodiment. Incidentally, in FIG. 9 and FIG. 10 the same components as those illustrated in FIG. 2 and FIG. 4 carry the same reference numerals.

As illustrated in FIG. 9, the video search system 10 according to the third example embodiment includes the object tag acquisition unit 110, the search query acquisition unit 120, the similarity calculation unit 130, the video search unit 140, and a scene information acquisition unit 180. That is, the video search system 10 according to the third example embodiment further includes a scene information acquisition unit 180 in addition to the configuration in the first example embodiment (see FIG. 2).

The scene information acquisition unit 180 is configured to obtain a scene information indicating a scene of the video. The scene information includes, for example, information about a position or location in which the video is captured, a time information, information indicating a situation and an atmosphere when the video is captured, or the like. The scene information may include other information that may be related to the scene of the video. As a more specific example of the scene information, the position information is, for example, a position information obtained from a GPS (Global Positioning System) or the like. The time information is information about a date and time obtained from a time stamp or the like. Furthermore, the information indicating the situation and the atmosphere or the like when the video is captured may include information obtained from the action of a photographer or a captured person. One scene information may be added to one video, or a plurality of scene informations may be added to one video in which the scene is switched. Furthermore, a plurality of scene informations may be added to a video of a certain period. For example, the time information obtained from the time stamp and the position information obtained from the GPS may be added to the video of a certain period, as the scene information. The scene information acquisition unit 180 may include a storage unit for storing the obtained scene information. The scene information obtained by the scene information acquisition unit 180 is configured to be outputted to the similarity calculation unit 130.

The similarity calculation unit 130 according to the third example embodiment may divide the video into a plurality of scene ranges on the basis of the scene information, and may calculate the similarity degree for each scene range. For example, the scene range may be set by using a deviation or bias of the scene information in the video. For example, when the position information about the position in which the video is captured is obtained as the scene information, the similarity calculation unit 130 divides the video by a predetermined time (e.g., 10 seconds), and calculates an average value for a latitude and longitude information included in the position information in each part of the video divided (hereinafter referred to as a “divisional video” as appropriate). Then, adjacent divisional videos are integrated as the same division when a difference in the calculated average value is less than a predetermined value (e.g., when there are divisional videos of 1, 2, 3, 4, and so on and when a difference between 3 and 4 is less than a predetermined value, 3 and 4 are integrated into 5 to be 1, 2, 5, and so on). Then, the averaging value is again calculated for the integrated divisional videos, and the same process is repeated until the difference becomes no longer less than the predetermined value. In this way, a video captured at a relatively close location will be set as a single scene.

The scene range may also be set by using the deviation or bias of the object tag. Alternatively, the scene range may be set by using information that appears in the video for a certain period or longer. For example, if the same object appears continuously for longer than a certain period, it may be set as a single scene range. In this case, the object tag may be used to identify the object that appears in the video.

As illustrated in FIG. 10, the video search system 10 may include the object tagging unit 150 and a scene information addition unit 190. That is, the video search system in the modified example illustrated in FIG. 4 may further include a scene information addition unit 190.

The scene information addition unit 190 automatically recognizes the scene of the video and adds the scene information, for example, by using a scene recognition model that is machine-learned in advance. A specific method of automatically adding the scene information can use the existing techniques/technologies, as appropriate. When the video search system 10 includes the scene information adding unit 190, even when the scene information is not added to the video, it is possible to perform a video search using the scene information. That is, the video search system 10 is configured to perform the video search after the scene information addition unit 190 adds the scene information to the video. On the other hand, when the video search system 10 does not include the scene information addition unit 190, a video to which the scene information is added may be prepared in advance. In this case, the scene information may be automatically added by video analysis, or may be manually added.

### (Description of Operation)

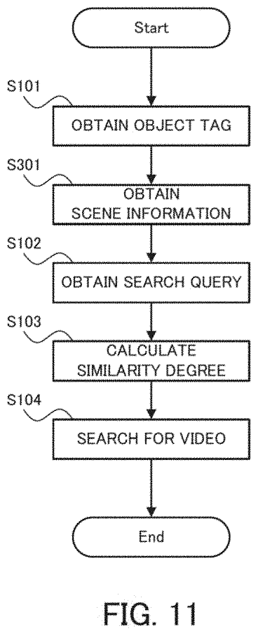

Next, a flow of operation of the video search system 10 according to the third example embodiment will be described with reference to FIG. 11. FIG. 11 is a flowchart illustrating the flow of the operation of the video search system according to the third example embodiment. Incidentally, in FIG. 11, the same steps as those illustrated in FIG. 5 carry the same reference numerals.

As illustrated in FIG. 11, in operation of the video search system 10 according to the third example embodiment, first, the object tag acquisition unit 110 obtains the object tag from the accumulated videos (the step S101). Also, the scene information acquisition unit 180 obtains the scene information from the accumulated videos (step S301). In addition, the search query acquisition unit 120 obtains the search query inputted by the user (the step S102). In the configuration in which the scene information addition unit 190 is provided, the scene information may be added by the scene information addition unit 190 before the step S301.

Subsequently, the similarity calculation unit 130 calculates the similarity degree between the object tag and the scene information, and the search query (the step S103). The similarity degree here may be calculated separately, as the similarity degree between the object tag and the search query, and the similarity degree between the scene information and the search query (i.e., two types of similarity degrees that are the similarity degree with respect to the object tag and the similarity degree with respect to the scene information may be calculated). Alternatively, the similarity degree may be calculated collectively, as the similarity degree between both the object tag and the scene information, and the search query (i.e., one type of similarity degree that takes into account both the object tag and the scene information may be calculated).

When the similarity degree is calculated, the video search unit 140 searches for and outputs the video corresponding to the search query based on the similarity degree (the step S104). When the similarly degree between the object tag and the search query and the similarity degree between the scene information and the search query are separately calculated, the video corresponding to the search query may be searched for on the basis of an overall similarity degree (e.g., an average value of the two similarity degrees) calculated from the two similarity degrees.

### (Technical Effect)

Next, a technical effect obtained by the video search system 10 according to the third example embodiment will be described.

As described in FIG. 9 to FIG. 11, in the video search system 10 according to the third example embodiment, the similarity degree is further calculated by using the scene information. In this way, the video can be search for in consideration of the situation, location, time, atmosphere, etc. in which the video is captured. As a result, it is possible to more accurately search for the video desired by the user.

### Fourth Example Embodiment

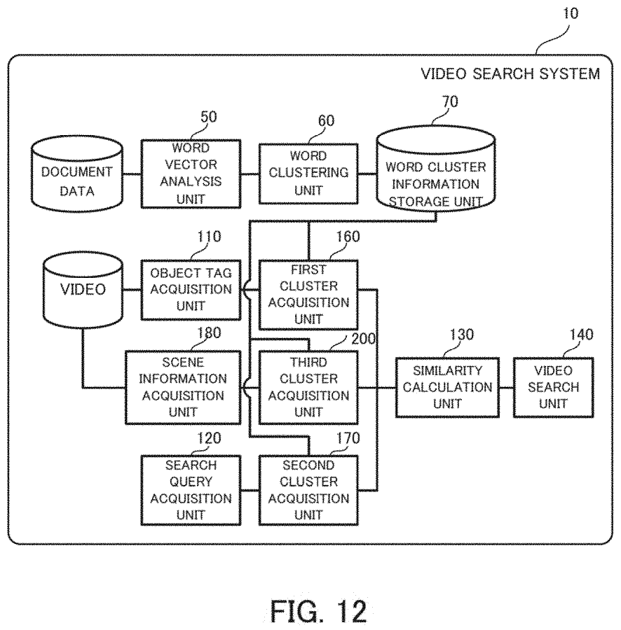

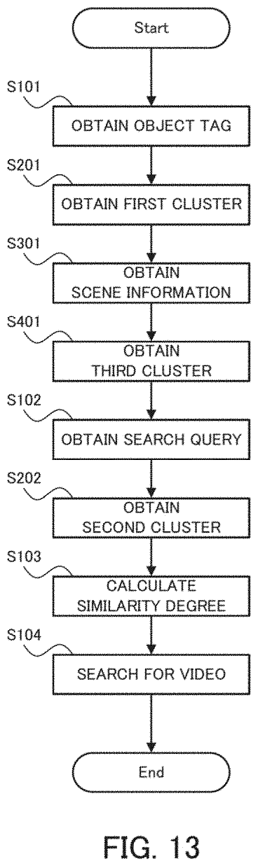

Next, the video search system 10 according to a fourth example embodiment will be described with reference to FIG. 12 and FIG. 13. The fourth example embodiment is partially different from the third example embodiment described above only in the configuration and operation (specifically, in that the cluster is used to calculate the similarity degree), and is substantially the same in the other parts. Therefore, the parts that differ from those of the third example embodiment will be described in detail below, and the other overlapping parts will not be described.

### (Functional Configuration)

First, a functional configuration of the video search system 10 according to the fourth example embodiment will be described with reference to FIG. 12. FIG. 12 is a block diagram illustrating a functional block provided by the video search system according to the fourth example embodiment. Incidentally, in FIG. 12, the same components as those illustrated in FIG. 9 carry the same reference numerals.

As illustrated in FIG. 12, the video search system 10 according to the fourth example embodiment includes the word vector analysis unit 50, the word clustering unit 60, the word cluster information storage unit 70, the object tag acquisition unit 110, the search query acquisition unit 120, the similarity calculation unit 130, the video search unit 140, the first cluster acquisition unit 160, the second cluster acquisition unit 170, the scene information acquisition unit 180, and a third cluster acquisition unit 200. That is, the video search system 10 according to the fourth example embodiment further includes the word vector analysis unit 50, the word clustering unit 60, the word cluster information storage unit 70, the first cluster acquisition unit 160, the second cluster acquisition unit 170, and a third cluster acquisition unit 200 in addition to the configuration in the third example embodiment (see FIG. 9). Incidentally, the first cluster acquisition unit 160 and the second cluster 170 may have the same configuration as that in the second example embodiment (see FIG. 6).

The third cluster acquisition unit 200 is configured to obtain a cluster (hereinafter referred to as a “third cluster” as appropriate) to which the information included in the scene information obtained by the scene information acquisition unit 180 (typically, the words included in the scene information) belongs, by using the information stored in the word cluster information storage unit 70 (i.e., the clustering result). The information about the third cluster obtained by the third cluster acquisition unit 200 is configured to be outputted to the similarity calculation unit 130.

### (Description of Operation)

Next, a flow of operation of the video search system 10 according to the fourth example embodiment will be described with reference to FIG. 13. FIG. 13 is a flowchart illustrating the flow of the operation of the video search system according to the fourth example embodiment. Incidentally, in FIG. 13, the same steps as those illustrated in FIG. 3, FIG. 8 and FIG. 11 carry the same reference numerals.

As illustrated in FIG. 13, in operation of the video search system 10 according to the fourth example embodiment, first, the object tag acquisition unit 110 obtains the object tag from the accumulated videos (the step S101). Then, the first cluster acquisition unit 160 obtains the first cluster to which the information included in the object tag belongs, by using the clustering result stored in the word cluster information storage unit 70 (step S201).

Then, the scene information acquisition unit 180 obtains the scene information from the accumulated videos (the step S301). Then, the third cluster acquisition unit 200 obtains the third cluster to which the information included in the scene information belongs, by using the clustering result stored in the word cluster information storage unit 70 (step S401).

The search query acquisition unit 120 then obtains the search query inputted by the user (the step S102). Then, the second cluster acquisition unit 170 obtains the second cluster to which the information included in the search query belongs, by using the clustering result stored in the word cluster information storage unit 70 (the step S202).

Subsequently, the similarity calculation unit 130 calculates the similarity degree between the object tag and the scene information, and the search query, by comparing the first cluster and the third cluster with the second cluster (the step S103). In other words, the similarity degree in the fourth example embodiment is calculated as the similarity degree between the first cluster (i.e., the cluster to which the object tag belongs) and the third cluster (i.e., the cluster to which the scene information belongs), and the second cluster (i.e., the cluster to which the search query belongs). When the similarity degree is calculated, the video search unit 140 searches for the video corresponding to the search query on the basis of the similarity degree (the step S104).

### (Technical Effect)

Next, a technical effect obtained by the video search system 10 according to the fourth example embodiment will be described.

As described in FIG. 12 and FIG. 13, in the video search system 10 according to the fourth example embodiment, the similarity degree is calculated by using information on the cluster to which the information included in the object tag, the scene information, and the search query belongs. In this way, the similarity degree between the object tag and the scene information, and the search query can be calculated as a more appropriate value. Therefore, it is possible to search for the video corresponding to the search query, more appropriately.

### <Supplementary Notes>

With respect to the example embodiments described above, the following Supplementary Notes will be described.

### (Supplementary Note 1)

A video search system described in Supplementary Note 1 is a video search system including: an object tag acquisition unit that obtains an object tag associated with an object that appears in a video; a search query acquisition unit that obtains a search query; a similarity calculation unit that calculates a similarity degree between the object tag and the search query; and a video search unit that searches for a video corresponding to the search query on the basis of the similarity degree.

### (Supplementary Note 2)

A video search system described in Supplementary Note 2 is the video search system according to claim 1, further including: a first cluster acquisition unit that obtains a first cluster to which information included in the object tag belongs; and a second cluster acquisition unit that obtains a second cluster to which information included in the search query belongs, wherein the similarity calculation unit compares the first cluster with the second cluster and calculates the similarity degree between the object tag and the search query.

### (Supplementary Note 3)

A video search system described in Supplementary Note 3 is the video search system described in Supplementary Note 2, wherein the first cluster is a cluster based on a vector that represents the object tag, and the second cluster is a cluster based on a vector that represents the search query.

### (Supplementary Note 4)

A video search system described in Supplementary Note 4 is the video search system described in any one of Supplementary Notes 1 to 3, wherein the similarity calculation unit calculates the similarity degree between the object tag and the search query on the basis of a length of a time in which the object appears in the video.

### (Supplementary Note 5)

A video search system described in Supplementary Note 5 is the video search system described in any one of Supplementary Notes 1 to 4, wherein the similarity calculation unit calculates the similarity between the object tag and the search query on the basis of a size of the object that appears in the video.

### (Supplementary Note 6)

A video search system described in Supplementary Note 6 is the video search system described in any one of Supplementary Notes 1 to 5, wherein the object tag includes a unique identification information that individually distinguishes between the objects.

### (Supplementary Note 7)

A video search system described in Supplementary Note 7 is the video search system described in any one of Supplementary Notes 1 to 6, further including an object information addition unit that associates the object tag with the object that appears in the video.

### (Supplementary Note 8)

A video search system described in Supplementary Note 8 is the video search system described in any one of Supplementary Notes 1 to 7, further including a scene information acquisition unit that obtains a scene information indicating a scene of the video, wherein the similarity calculation unit calculates a similarity degree between the object tag and the scene information, and the search query.

### (Supplementary Note 9)

A video search system described in Supplementary Note 9 is the video search system described in Supplementary Note 8, further including a scene information addition unit that adds the scene information to the video.

### (Supplementary Note 10)

A video search system described in Supplementary Note 10 is the video search system described in Supplementary Note 8 or 9, wherein the similarity calculation unit divides the video into a plurality of scene ranges on the basis of the scene information and calculates the similarity degree for each of the scene ranges.

### (Supplementary Note 11)

A video search system described in Supplementary Note 11 is the video search system described in any one of Supplementary Notes 1 to 10, wherein the search query is a natural language.

### (Supplementary Note 12)

A video search method described in Supplementary Note 12 is a video search method including: obtaining an object tag associated with an object that appears in a video; obtaining a search query; calculating a similarity degree between the object tag and the search query; and searching for a video corresponding to the search query on the basis of the similarity degree.

### (Supplementary Note 13)

A computer program described in Supplementary Note 13 is a computer program that operates a computer: to obtain an object tag associated with an object that appears in a video; to obtain a search query; to calculate a similarity degree between the object tag and the search query; and to search for a video corresponding to the search query on the basis of the similarity degree.

### (Supplementary Note 14)

A recording medium described in Supplementary Note 14 is a recording medium on which the computer program described in Supplementary Note 13 is recorded.

This disclosure is not limited to the examples described above and is allowed to be changed, if desired, without departing from the essence or spirit of this disclosure which can be read from the claims and the entire specification. A video search system, a video search method, and a computer program with such modifications are also intended to be within the technical scope of this disclosure.

### DESCRIPTION OF REFERENCE CODES

10 Video search system
50 Word vector analysis unit
60 Word clustering unit
70 Word cluster information storage unit
110 Object Tag acquisition unit
120 Search Query acquisition unit
130 Similarity calculation unit
140 Video search unit
150 Object tagging unit
160 First cluster acquisition unit
170 Second cluster acquisition unit
180 Scene information acquisition unit
190 Scene information addition unit
200 Third cluster acquisition unit

What is claimed is:

1. A video search system comprising:
at least one memory that is configured to store instructions; and
at least one processor that is configured to execute instructions
to obtain an object tag associated with an object that appears in a video;
to obtain a search query;
to calculate a similarity degree between the object tag and the search query; and
to search for a video corresponding to the search query on the basis of the similarity degree.

2. The video search system according to claim 1, further comprising: a processor that is configured to execute instructions
to obtain a first cluster to which information included in the object tag belongs; and
to obtain a second cluster to which information included in the search query belongs, wherein
the processor compares the first cluster with the second cluster and calculates the similarity degree between the object tag and the search query.

3. The video search system according to claim 2, wherein
the first cluster is a cluster based on a vector that represents the object tag, and
the second cluster is a cluster based on a vector that represents the search query.

4. The video search system according to claim 1, wherein the processor calculates the similarity degree between the object tag and the search query on the basis of a length of a time in which the object appears in the video.

5. The video search system according to claim 1, wherein the processor calculates the similarity between the object tag and the search query on the basis of a size of the object that appears in the video.

6. The video search system according to claim 1, wherein the object tag includes a unique identification information that individually distinguishes between the objects.

7. The video search system according to claim 1, further comprising a processor that is configured to execute instructions to associate the object tag with the object that appears in the video.

8. The video search system according to claim 1, further comprising a processor that is configured to execute instructions to obtain a scene information indicating a scene of the video, wherein
the processor calculates a similarity degree between the object tag and the scene information, and the search query.

9. The video search system according to claim 8, further comprising a processor that is configured to execute instructions to add the scene information to the video.

10. The video search system according to claim 8, wherein the processor divides the video into a plurality of scene ranges on the basis of the scene information and calculates the similarity degree for each of the scene ranges.

11. The video search system according to claim 1, wherein the search query is a natural language.

12. A video search method comprising:
obtaining an object tag associated with an object that appears in a video;
obtaining a search query;
calculating a similarity degree between the object tag and the search query; and
searching for a video corresponding to the search query on the basis of the similarity degree.

13. A non-transitory recording medium on which a computer program that allows a computer to execute a video search method is recorded, the video search method comprising:
obtaining an object tag associated with an object that appears in a video;
obtaining a search query;
calculating a similarity degree between the object tag and the search query; and
searching for a video corresponding to the search query on the basis of the similarity degree.
